(19) United States
(12) Patent Application Publication
(10) Pub. No.: US 2021/0309258 A1
(43) Pub. Date: Oct. 7, 2021

(54) OPERATION MANAGEMENT DEVICE, OPERATION MANAGEMENT METHOD, AND TRANSPORTATION SYSTEM

(71) Applicants: TOYOTA JIDOSHA KABUSHIKI KAISHA, Toyota-shi (JP); DENSO CORPORATION, Kariya-city (JP)

(72) Inventors: Kenji OKAZAKI, Toyota-shi (JP); Hiroshi HIGASHIDE, Toyota-shi (JP); Keiichi UNO, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 17/215,694

(22) Filed: Mar. 29, 2021

(30) Foreign Application Priority Data
Apr. 2, 2020 (JP) 2020-066592

(51) Int. Cl. B60W 60/00; B60W 50/12; B60W 30/18; G08G 1/00

(52) U.S. Cl. CPC B60W 60/0018; B60W 50/12; B60W 2510/0638; B60W 30/18009; G08G 1/20; B60W 60/0027

(57) ABSTRACT

When a delayed vehicle exists and a non-uniformity index of operation intervals becomes equal to or greater than an allowable value, an operation management device generates a temporary running plan for driving the delayed vehicle to run at a prescribed first scheduled speed and another vehicle to run at a speed reduced lower than the first scheduled speed, and when the non-uniformity index of the operation intervals is reduced to a non-uniformity allowable value greater than zero as a result of the multiple vehicles running in accordance with the temporary running plan, the device generates a return running plan for driving the other vehicle to run at the first scheduled speed and the delayed vehicle to run at a speed temporarily increased higher than the first scheduled speed.

### CROSS REFERENCE TO RELATED APPLICATION

This application claims priority to Japanese Patent Application No. 2020-066592 filed on Apr. 2, 2020, which is incorporated herein by reference in its entirety including the specification, claims, drawings, and abstract.

### TECHNICAL FIELD

This description discloses an operation management device managing operation of multiple vehicles autonomously running along a prescribed running route, an operation management method, and a transportation system having the operation management device.

### BACKGROUND

In recent years, a transportation system using a vehicle capable of autonomous running has been proposed. For example, JP 2000-264210 A discloses a vehicle traffic system using a vehicle capable of autonomously running along a dedicated route. This vehicle traffic system includes multiple vehicles running along a dedicated route, and a control system operating the multiple vehicles. The control system transmits a departure command and a course command to the vehicles in accordance with an operation plan.

A vehicle may be delayed with respect to an operation plan due to various reasons. For example, when a vehicle is crowded, it takes time for users to get on and off, and the departure timing of the vehicle may be delayed with respect to the operation plan. When running on a general road, the vehicle may be delayed with respect to the operation plan due to traffic congestion, etc. If one vehicle is delayed, passengers may concentrate on the delayed vehicle, resulting in crowdedness and further increase in delay. Therefore, when a delayed vehicle exists and the extent of non-uniformity of operation intervals becomes equal to or greater than an allowable value, it is necessary to take measures to suppress the concentration of passengers on the delayed vehicle.

However, JP 2000-264210 A presupposes that the vehicles run in accordance with the operation plan and gives no consideration to the case where the vehicle is delayed with respect to the operation plan. Therefore, in JP 2000-264210 A, the delay of the vehicle cannot be appropriately eliminated, and convenience of a transportation system may be reduced.

Therefore, this description discloses an operation management device, an operation management method, and a transportation system capable of further improving the convenience of the transportation system.

### SUMMARY

An operation management device disclosed in this description is an operation management device comprising: a plan generation section generating a running plan for each of multiple vehicles autonomously running along a prescribed running route; a communication device transmitting the running plan to a corresponding vehicle and receiving running information indicative of an operation status from the vehicle; and an operation monitoring section determining presence or absence of a delayed vehicle delayed with respect to the running plan and calculating a non-uniformity index of operation intervals of the multiple vehicles based on the running information, wherein when the delayed vehicle exists and the non-uniformity index becomes equal to or greater than an allowable value, the plan generation section generates a temporary running plan for driving the delayed vehicle to run at a prescribed first scheduled speed and another vehicle to run at a speed reduced lower than the first scheduled speed, and wherein when the non-uniformity index of the operation intervals is reduced to a non-uniformity allowable value greater than zero as a result of the multiple vehicles running in accordance with the temporary running plan, the plan generation section generates a return running plan for driving the other vehicle to run at the first scheduled speed and the delayed vehicle to run at a speed temporarily increased higher than the first scheduled speed.

With such a configuration, when a delayed vehicle exists, the speed of the other vehicle is reduced, so that the operation intervals can quickly be made near uniform. On the other hand, by stopping the speed reduction of the other vehicle before the operation intervals become completely uniform, the travel time of the other vehicle can be prevented from becoming excessively long. As a result, the convenience of the transportation system can be further improved.

In this case, the operation management device may further include an allowable value calculation section calculating the non-uniformity allowable value in advance by simulation.

By calculating the non-uniformity allowable value used as a reference value for stopping the speed reduction by simulation, the speed reduction can be stopped at a more appropriate timing, and prolongation of the travel time can be more reliably prevented.

The allowable value calculation section may input, as a parameter of the simulation, at least one of passenger information transmitted from the vehicle as information about passengers of the vehicle, and waiting person information transmitted from a station terminal disposed at a station on the running route as information about waiting persons waiting for the vehicle at the station.

The number and attributes of passengers and waiting persons greatly affect the boarding/alighting time, as well as a probability of occurrence of delay. By calculating the non-uniformity allowable value in consideration of the information about passengers and waiting persons, the speed reduction can be stopped at a more appropriate timing, and prolongation of the travel time can be more reliably prevented.

An operation management method disclosed in this description is an operation management method comprising: generating a running plan for each of multiple vehicles autonomously running along a prescribed running route; transmitting the running plan to a corresponding vehicle; receiving running information indicative of an operation status from the vehicle; and determining presence or absence of a delayed vehicle delayed with respect to the running plan and calculating a non-uniformity index of operation intervals of the multiple vehicles based on the running information, wherein when the delayed vehicle exists and the non-uniformity index becomes equal to or greater than an allowable value, a temporary running plan is generated for driving the delayed vehicle to run at a prescribed first scheduled speed and another vehicle to run at a speed reduced lower than the first scheduled speed, and wherein when the non-uniformity index of the operation intervals is reduced to a non-uniformity allowable value greater than zero as a result of the multiple vehicles running in accordance with the temporary running plan, a return running plan is generated for driving the other vehicle to run at the first scheduled speed and the delayed vehicle to run at a speed temporarily increased higher than the first scheduled speed.

A transportation system disclosed in this description is a transportation system comprising: multiple vehicles autonomously running in accordance with a running plan along a prescribed running route; and an operation management device managing an operation of the multiple vehicles, wherein the operation management device includes a plan generation section generating the running plan for each of the multiple vehicles, a communication device transmitting the running plan to a corresponding vehicle and receiving running information indicative of an operation status from the vehicle, and an operation monitoring section determining presence or absence of a delayed vehicle delayed with respect to the running plan and calculating a non-uniformity index of operation intervals of the multiple vehicles based on the running information, wherein when the delayed vehicle exists, the plan generation section generates a temporary running plan for driving the delayed vehicle to run at a prescribed first scheduled speed and another vehicle to run at a speed reduced lower than the first scheduled speed, and wherein when the non-uniformity index of the operation intervals is reduced to a non-uniformity allowable value greater than zero as a result of the multiple vehicles running in accordance with the temporary running plan, the plan generation section generates a return running plan for driving the other vehicle to run at the first scheduled speed and the delayed vehicle to run at a speed temporarily increased higher than the first scheduled speed.

According to the technique disclosed in this description, the convenience of the transportation system can be further improved.

### BRIEF DESCRIPTION OF DRAWINGS

Embodiments of the present disclosure will be described based on the following figures, wherein:

FIG. 1 is an image diagram of a transportation system;

FIG. 2 is a block diagram of the transportation system;

FIG. 3 is a block diagram showing a physical configuration of an operation management device;

FIG. 4 is a diagram showing an example of a running plan used in the transportation system of FIG. 1;

FIG. 5 is an operation timing chart of vehicles autonomously running in accordance with the running plan of FIG. 4;

FIG. 6 is a diagram showing an operation time schedule when a vehicle is delayed;

FIG. 7 is a flowchart showing a flow of modification of the running plan;

FIG. 8 is a diagram showing an example of a temporary running plan;

FIG. 9 is an operation timing chart of the vehicles autonomously running in accordance with the temporary running plan of FIG. 8;

FIG. 10 is a diagram showing an example of a return running plan; and

FIG. 11 is an operation timing chart of the vehicles autonomously running in accordance with the temporary running plan of FIG. 8 and the return running plan of FIG. 10.

### DESCRIPTION OF EMBODIMENTS

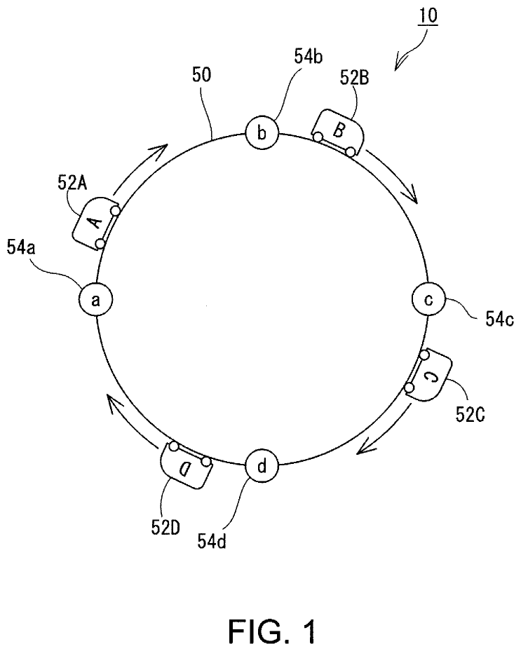

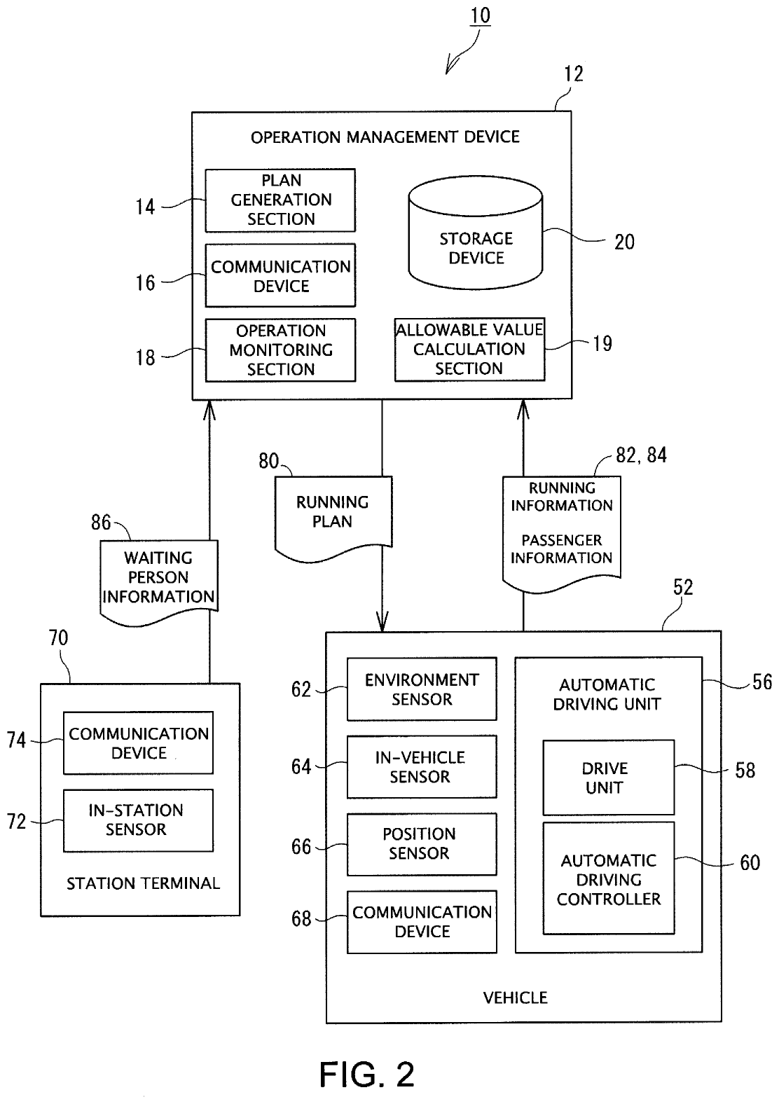

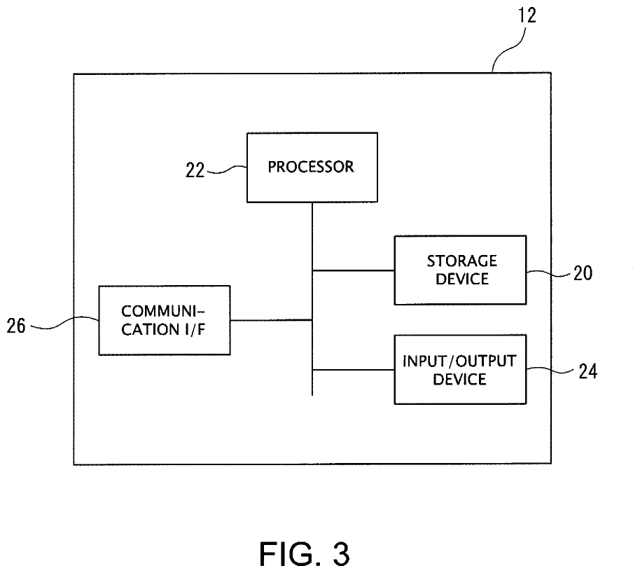

A configuration of a transportation system 10 will now be described with reference to the drawings. FIG. 1 is an image diagram of the transportation system 10, and FIG. 2 is a block diagram of the transportation system 10. FIG. 3 is a block diagram showing a physical configuration of an operation management device 12.

This transportation system 10 is a system for transporting an unspecified number of users along a running route 50 prescribed in advance. The transportation system 10 has multiple vehicles 52A to 52D capable of autonomously running along the running route 50. Multiple stations 54a to 54d are set along the running route 50. In the following description, when the multiple vehicles 52A to 52D are not distinguished, the alphabetical suffix is omitted, and the vehicles are referred to as “vehicles 52”. Similarly, multiple stations 54a to 54d are referred to as “stations 54” when not distinguished.

The multiple vehicles 52 go around in one direction along the running route 50, forming a line of vehicles. The vehicles 52 make a brief stop at each of the stations 54. Users get on or off the vehicles 52 by using the timing of the brief stop of the vehicles 52. Therefore, in this example, each of the vehicles 52 functions as a shared bus transporting an unspecified number of users from one of the stations 54 to another station 54. The operation management device 12 (not shown in FIG. 1, see FIGS. 2 and 3) manages the operation of the multiple vehicles 52. In this example, the operation management device 12 controls the operation of the multiple vehicles 52 to perform equal interval operation. The equal interval operation is an operation mode in which equal departure intervals of the vehicles 52 are achieved at each of the station 54. Therefore, the equal interval operation is an operation mode in which, for example, when the departure interval at the station 54a is 15 minutes, the departure interval at the other stations 54b, 54c, 54d is also 15 minutes.

The elements constituting the transportation system 10 will more specifically be described. The vehicles 52 autonomously run in accordance with a running plan 80 provided by the operation management device 12. The running plan 80 defines the running schedule of the vehicles 52. In this example, as described in detail later, the running plan 80 defines the departure timing of the vehicles 52 at the stations 54a to 54d. The vehicles 52 autonomously run so that the vehicles can depart at the departure timing prescribed in the running plan 80. In other words, the vehicles 52 make all determinations in terms of a running speed between stations, stopping at a traffic light, etc., and whether it is necessary to overtake another vehicle.

As shown in FIG. 2, the vehicle 52 has an automatic driving unit 56. The automatic driving unit 56 is roughly divided into a drive unit 58 and an automatic driving controller 60. The drive unit 58 is a basic unit for driving the vehicle 52 to run, and includes a prime mover, a power transmission device, a brake device, a running device, a suspension device, and a steering device, for example. The automatic driving controller 60 controls the drive of the drive unit 58 to cause the vehicle 52 to autonomously run. The automatic driving controller 60 is, for example, a computer having a processor and a memory. This “computer” includes a microcontroller having a computer system incorporated in an integrated circuit. The processor refers to a processor in a broad sense, including a general-purpose processor (e.g., CPU: Central Processing Unit) and a dedicated processor (e.g., GPU: Graphics Processing Unit, ASIC: Application Special Integrated Circuit, FPGA: Field Programmable Gate Array, a programmable logic device).

To enable autonomous running, the vehicle 52 is further equipped with an environment sensor 62 and a position sensor 66. The environment sensor 62 detects the surrounding environment of the vehicle 52, and includes a camera, Lidar, a millimeter-wave radar, a sonar, and a magnetic sensor, for example. Based on the detection result of the environment sensor 62, the automatic driving controller 60 recognizes a type of an object around the vehicle 52, a distance to the object, road marking (e.g., a white line) on the running route 50, traffic signs, etc. The position sensor 66 detects the current position of the vehicle 52, and is a GPS receiver, for example. The detection result of the position sensor 66 is also sent to the automatic driving controller 60. Based on the detection results of the environment sensor 62 and the position sensor 66, the automatic driving controller 60 controls acceleration/deceleration and steering of the vehicle 52. A status of control by the automatic driving controller 60 is transmitted as running information 82 to the operation management device 12. The running information 82 includes the current position of the vehicle 52.

The vehicle 52 is further provided with an in-vehicle sensor 64 and a communication device 68. The in-vehicle sensor 64 is a sensor detecting a state of the inside of the vehicle 52, or particularly, the number and attributes of passengers. The attributes are characteristics affecting the boarding/alighting time of passengers and may include at least one of whether a wheelchair is used, whether a white cane is used, whether a stroller is used, whether an orthosis is used, and age groups. For example, the in-vehicle sensor 64 is a camera imaging the inside of the vehicle and a weight sensor detecting the total weight of the passengers. The information detected by the in-vehicle sensor 64 is transmitted as passenger information 84 to the operation management device 12.

The communication device 68 is a device wirelessly communicating with the operation management device 12. The communication device 68 is capable of Internet communication via, for example, a wireless LAN such as WiFi (registered trademark) or a mobile data communication service provided by a mobile phone company, etc. The communication device 68 receives the running plan 80 from the operation management device 12 and transmits the running information 82 and the passenger information 84 to the operation management device 12.

Each of the stations 54 is provided with a station terminal 70. The station terminal 70 has a communication device 74 and an in-station sensor 72. The in-station sensor 72 is a sensor detecting a state of the station 54, or particularly, the number and attributes of waiting persons waiting for the vehicle 52 at the station 54. For example, the in-station sensor 72 is a camera imaging the station 54 and a weight sensor detecting the total weight of the waiting persons. The information detected by the in-station sensor 72 is transmitted as waiting person information 86 to the operation management device 12. The communication device 16 is disposed to enable the transmission of the waiting person information 86.

The operation management device 12 monitors an operation status of the vehicles 52 and controls the operation of the vehicle 52 in accordance with the operation status. The operation management device 12 is physically a computer having a processor 22, a storage device 20, an input/output device 24, and a communication I/F 26, as shown in FIG. 3. The processor refers to a processor in a broad sense, including a general-purpose processor (e.g., CPU) and a dedicated processor (e.g., GPU, ASIC, FPGA, a programmable logic device). The storage device 20 may include at least one of semiconductor memories (e.g., RAM, ROM, and a solid-state drive) and magnetic disks (e.g., a hard disk drive). Although the operation management device 12 is shown as a single computer in FIG. 3, the operation management device 12 may be made up of multiple physically separated computers.

As shown in FIG. 2, the operation management device 12 functionally has a plan generation section 14, a communication device 16, an operation monitoring section 18, an allowable value calculation section 19, and the storage device 20. The plan generation section 14 generates the running plan 80 for each of the multiple vehicles 52. The plan generation section 14 modifies and regenerates the generated running plan 80 depending on the operation status of the vehicles 52. The generation and modification of the running plan 80 will be described in detail later.

The communication device 16 is a device for wireless communication with the vehicles 52 and is capable of Internet communication using WiFi or mobile data communication, for example. The communication device 16 transmits the running plan 80 generated and regenerated by the plan generation section 14 to the vehicles 52 and receives the running information 82 and the passenger information 84 from the vehicles 52.

The operation monitoring section 18 acquires the operation status of the vehicles 52 based on the running information 82 transmitted from each of the vehicles 52. As described above, the running information 82 includes the current position of the vehicle 52. The operation monitoring section 18 compares the position of each of the vehicles 52 with the running plan 80 and calculates a delay amount of the vehicle 52 with respect to the running plan 80. This delay amount may be a difference in distance between a target position and the actual position of the vehicle 52 or may be a difference in time between a target time of arrival at a specific point and an actual arrival time. In any case, the operation monitoring section 18 calculates the delay amount for each of the vehicles 52 and identifies the vehicle 52 having a delay amount exceeding a prescribed reference delay amount as a delayed vehicle. The operation monitoring section 18 also calculates operation intervals of the multiple vehicles 52 based on the positions of the vehicles 52. The operation intervals calculated in this case may be temporal intervals or distance intervals. The operation monitoring section 18 also calculates a non-uniformity index UE of the operation intervals of the multiple vehicles 52 based on the calculated operation intervals, and this will be described later.

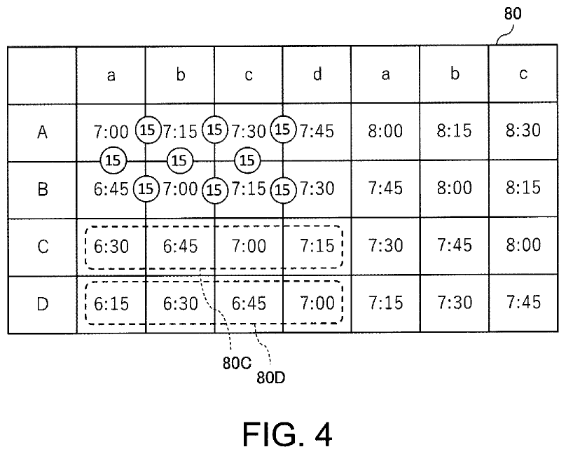

The generation and modification of the running plan 80 in the operation management device 12 will be described in detail. FIG. 4 is a diagram showing an example of the running plan 80 used in the transportation system 10 of FIG. 1. In the example of FIG. 1, the line of vehicles is made up of the four vehicles 52A to 52D, and the four stations 54a to 54d are arranged at equal intervals along the running route 50. In this example, it is assumed that the time required for each of the vehicles 52 to go one lap around the running path 50; i.e., a circling time TC, is 60 minutes.

In this case, the operation management device 12 generates the running plan 80 such that the departure interval of the vehicle 52 at each of the stations 54 is set to the time obtained by dividing the circling time TC by the number of vehicles 52; i.e., 60/4=15 minutes. In the running plan 80, as shown in FIG. 4, only the departure timing at each of the stations 54 is recorded. For example, in a running plan 80D transmitted to the vehicle 52D, a target time of departure of the vehicle 52D from each of the stations 54a to 54d is recorded.

In the running plan 80, only the time schedule of one round is usually recorded and is transmitted from the operation management device 12 to the vehicles 52 at the timing of arrival of each of the vehicles 52 at a specific station, for example, the station 54a. For example, the vehicle 52C receives the running plan 80C of one round, from the operation management device 12 at the timing of arrival at the station 54a (e.g., at 6:30), and the vehicle 52D receives the running plan 80C of one lap, from the operation management device 12 at the timing of arrival at the station 54a (e.g., at 6:15).

However, when the running plan 80 is modified due to a delay of the vehicle 52, etc., a new running plan 80 is transferred from the operation management device 12 to the vehicle 52 even if the vehicle 52 has not arrived at the station 54a. When receiving the new running plan 80, the vehicles 52 discard the previous running plan 80 and autonomously run in accordance with the new running plan 80.

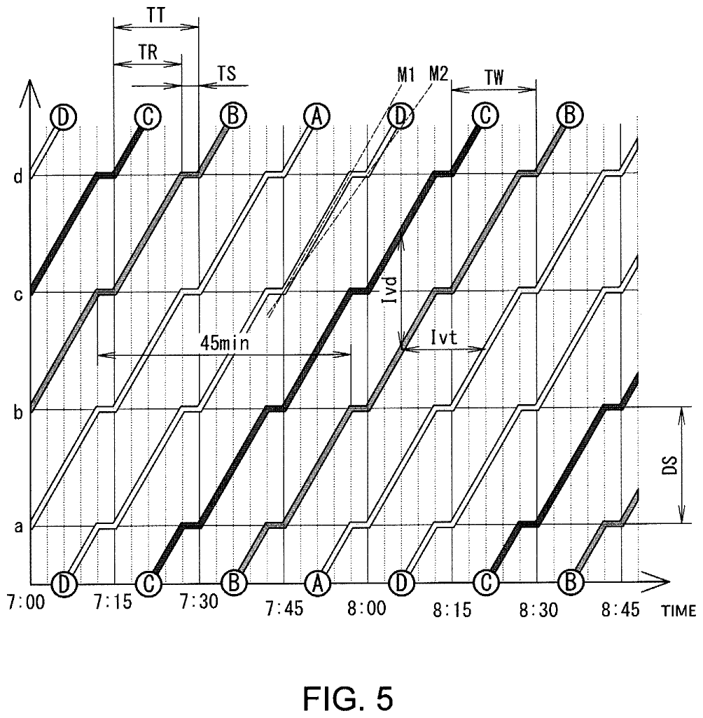

The vehicles 52 autonomously run in accordance with the received running plan 80. FIG. 5 is an operation timing chart of the vehicles 52A to 52D autonomously running in accordance with the running plan 80 of FIG. 4. In FIG. 5, the horizontal axis represents time, and the vertical axis represents the positions of the vehicles 52. Before explaining how the vehicles 52 run, meanings of various parameters used in the following description will be briefly described.

In the following description, a distance from one of the stations 54 to the next station 54 is referred to as an “inter-station distance DT”. A time from a departure of the vehicle 52 from one of the stations 54 to a departure from the next station 54 is referred to as an “inter-station required time TT”, and a time of stop of the vehicle 52 at the station 54 for boarding and alighting of users is referred to as a “stop time TS”. A time from a departure from one of the stations 54 to an arrival at the next station 54; i.e., a time obtained by subtracting the stop time TS from the inter-station required time TT, is referred to as an “inter-station running time TR”.

A value obtained by dividing a travel distance by a travel time including the stop time TS is referred to as a “scheduled speed VS”, and a value obtained by dividing a travel distance by a travel time not including the stop time TS is referred to as an “average running speed VA”. A slope of a line M1 of FIG. 5 represents the average running speed VA, and a slope of a line M2 of FIG. 5 represents the scheduled speed VS.

As described above, the operation interval calculated by the operation monitoring section 18 may be a temporal interval or a distance interval. The temporal interval is a temporal interval of the two vehicles 52 passing through the same position and is, for example, an interval Ivt of FIG. 5. The distance interval is a distance interval between two vehicles 52 at the same time and is, for example, an interval Ivd of FIG. 5. Regardless of whether the temporal interval or the distance interval, the operation intervals are obtained for the number of vehicles 52 at an arbitrary timing. For example, in the example of FIG. 5, a total of four operation intervals are obtained at an arbitrary timing as the operation interval between the vehicle 52A and the vehicle 52B, the operation interval between the vehicle 52B and the vehicle 52C, the operation interval between the vehicle 52C and the vehicle 52D, and the operation interval between the vehicle 52D and the vehicle 52A.

The operation monitoring section 18 also calculates the non-uniformity index UE of the operation intervals at an arbitrary timing based on such operation intervals. The calculation method of the non-uniformity index UE of the operation interval is not particularly limited so long as a parameter representing a variation in operation interval is obtained. Therefore, for example, a variance value of the four operation intervals may be calculated as the non-uniformity index UE of the operation intervals. In this case, the non-uniformity index UE is calculated by the following Eq. 1. In Eq. 1, x, is the operation interval, x with an overline is an average value of multiple operation intervals, and n is the number of vehicles.

$$\begin{matrix}[ Math . 1 ] & \\ U E = \frac{1}{n} {\sum }_{i = 1}^{n} {( {x}_{i} - \overline{x} )}^{2} & Eq . 1\end{matrix}$$

The operation of the vehicles 52 will be described with reference to FIG. 5.

According to the running plan 80 of FIG. 4, the vehicle 52A must depart the station 54a at 7:00 and then depart the station 54b 15 minutes, later at 7:15. The vehicle 52A controls the average running speed VA so as to complete the movement from the station 54a to the station 54b and the boarding/alighting of users in the 15 minutes.

Specifically, the vehicle 52 preliminarily stores the standard stop time TS required for the boarding/alighting of users as a planned stop time TSp. The vehicle 52 calculates the time obtained by subtracting the planned stop time TSp from the departure time at the station 54 prescribed in the running plan 80 as the arrival target time at the station 54. For example, when the planned stop time TSp is 3 minutes, the arrival target time of the vehicle 52A at the station 54b is 7:12. The vehicle 52 controls the running speed so that the vehicle 52 can arrive at the next station 54 by the arrival target time calculated in this way.

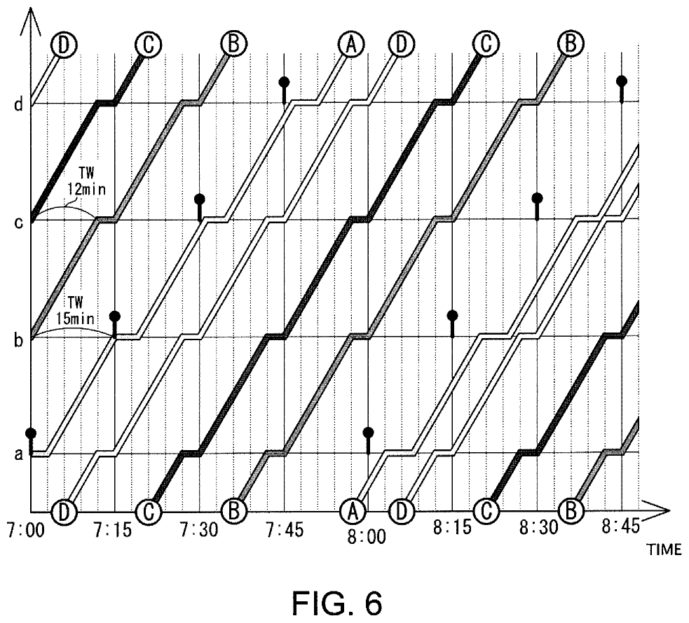

Some or all of the vehicles 52 may be delayed with respect to the running plan 80 due to a traffic congestion status of the running route 50, an increase in the number of users, etc. When such a delay occurs, the travel time of the passengers on the vehicle 52 being delayed (hereinafter referred to as “delayed vehicle”) increases, and the convenience of the transportation system 10 lowers. Furthermore, if the delayed state is left as is, a negative spiral may occur such that concentration of users on the delayed vehicle further increases the delay. This negative spiral will be described with reference to FIG. 6. FIG. 6 is a diagram showing an operation time schedule when the vehicle 52A is delayed.

In FIG. 6, a pin-shaped mark with a black circle at a tip of a bar indicates the departure timing of the vehicle 52A prescribed in the running plan 80. In the example of FIG. 6, the vehicles 52 move from one station to the next station 54 in 12 minutes (i.e., TR=12 minutes) in a normal state without a delay and stop at each of the stations 54 for 3 minutes for boarding/alighting of users (i.e., TS=3 minutes).

It is assumed that after the vehicle 52A arrives at the station 54a, a longer time is required for boarding/alighting of users and makes the stop time TS to 6 minutes. In this case, the vehicle 52A departs from the station 54a with a delay of 3 minutes. Normally, to make up for this delay of 3 minutes, the vehicle 52A needs to increase the average running speed VA and shorten the inter-station running time TR. However, it is difficult to significantly improve the average running speed VA due to a speed limit, etc. Additionally, when the inter-station distance DT is short, it is difficult to significantly reduce the inter-station running time TR even if the average running speed VA is slightly improved.

In the example of FIG. 6, for this reason, the vehicle 52A arrives at the station 54b with a delay of 3 minutes without being able to eliminate the delay. If no delay exists, a time from the departure of one vehicle to the arrival of the next vehicle 52 (hereinafter referred to as a “maximum waiting time TW”) at each of the stations 54 is 12 minutes. However, as shown in FIG. 6, if the arrival of the vehicle 52A at the station 54b is delayed by 3 minutes, the maximum waiting time TW from the departure of the vehicle 52B to the arrival of the vehicle 52A at the station 54b is 15 minutes. In this case, the number of users wishing to get on the vehicle 52A tends to be larger than in the case when no delay exists. As the number of users increases, the stop time TS of the vehicle 52A at the station 54b also increases, and the delay is more likely to increase. As the delay increases, the maximum waiting time TW at the next station 54c increases along with the number of users, and the delay further increases.

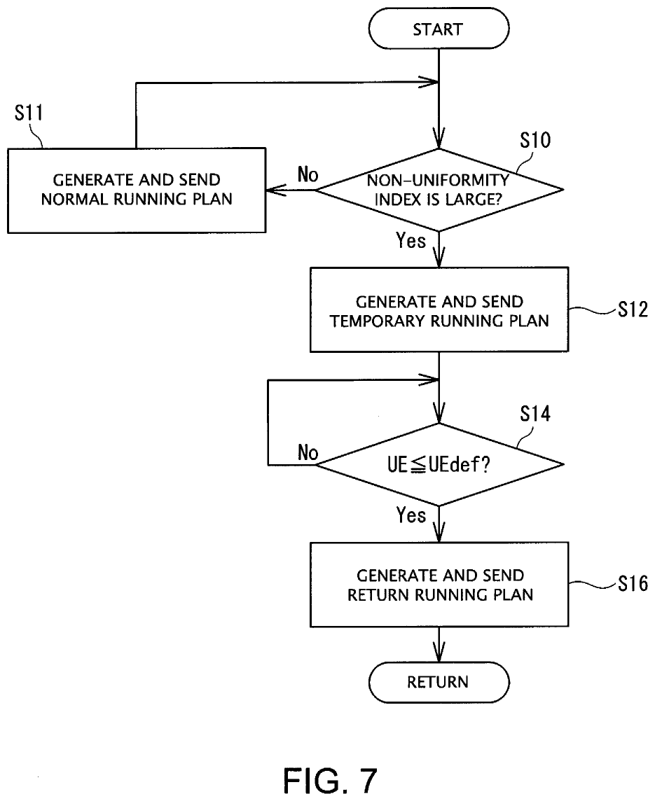

In this way, once a delay occurs, the delay may cause a negative spiral in which the delay further increases. Therefore, when a delayed vehicle exists and the non-uniformity index of the operation intervals becomes equal to or greater than an allowable value, the operation management device 12 modifies and regenerates the running plan 80 so as to eliminate the non-uniformity of the operation intervals due to the delay. FIG. 7 is a flowchart showing a flow of modification of the running plan 80.

The operation monitoring section 18 periodically confirms the non-uniformity index of the operation intervals due to a delay with respect to the running plan 80 (S10). When no delayed vehicle exists and the non-uniformity index is less than the allowable value (No at S10), the normal running plan 80 is generated and sent (S11). Specifically, the running plan of the multiple vehicles 52 running at equal intervals is generated and sent at the timing when each of the vehicle 52 arrives at the station 54a.

On the other hand, when the non-uniformity index of the operation intervals becomes equal to or greater than the allowable value as a result of occurrence of a delayed vehicle (Yes at S10), the plan generation section 14 generates and sends a temporary running plan 80α for eliminating the non-uniformity of the operation intervals due to the delay (S12). As described in detail later, the temporary running plan 80α is a running plan for driving the delayed vehicle to run at a first scheduled speed VS1 that is a reference scheduled speed and temporarily making the speed of the vehicles 52 other than the delayed vehicle lower than the first scheduled speed VS1 so as to eliminate the non-uniformity of the operation intervals.

As the multiple vehicles 52 run in accordance with this temporary running plan 80α, the non-uniformity index UE of the operation intervals gradually decreases. Therefore, after sending the temporary running plan, the plan generation section 14 periodically confirms whether the non-uniformity index UE has decreased to a prescribed non-uniformity allowable value UEdef (S14). The non-uniformity allowable value UEdef is a value calculated in advance by the allowable value calculation section 19 and is a value larger than zero. The calculation of this non-uniformity allowable value UEdef will also be described in detail later.

If the non-uniformity index UE is equal to or less than the non-uniformity allowable value UEdef (Yes at S14), the plan generation section 14 generates and sends a return running plan 80β (S16). The return running plan 80β is a running plan for driving the other vehicles 52 to run at the first scheduled speed VS1 while temporarily making the speed of the delayed vehicle higher than the first scheduled speed VS1 so as to eliminate the remaining non-uniformity of the operation intervals. By generating and sending the return running plan 80β, the speed reduction of the other vehicles 52 is canceled before the operation intervals become completely equal. As a result, the travel time of users using the other vehicles 52 can be prevented from becoming excessively long, and the convenience of the transportation system can be improved. After generating and sending the return running plan 80β, the process returns to step S10, and the non-uniformity index of the operation intervals is monitored again.

The generation of the temporary running plan 80α and the return running plan 80β will be described with specific examples. It is assumed that the vehicle 52A has departed from the station 54a with a delay of 6 minutes with respect to the running plan 80 of FIG. 4. In this case, the vehicle 52A is detected as a delayed vehicle. When the delayed vehicle 52A exists, the operation interval between the delayed vehicle 52A and the preceding vehicle 52B is naturally widened, and the operating interval between the delayed vehicle 52A and the following vehicle 52D is narrowed. In other words, the operation intervals of the multiple vehicles 52 become non-uniform. The plan generation section 14 generates the running plan 80 for eliminating the non-uniformity of the operation intervals as the temporary running plan 80α.

In this case, it is conceivable that a method for making the operation intervals uniform includes accelerating the delayed vehicle 52A so as to narrow the operation interval between the delayed vehicle 52A and the vehicle 52B. However, as described above, it is difficult to accelerate the delayed vehicle 52A such that the operation interval can be significantly shortened. Therefore, in the temporary running plan 80α, the scheduled speed VS of the vehicles 52B to 52D other than the delayed vehicle 52A is temporarily reduced so as to make the operation intervals uniform.

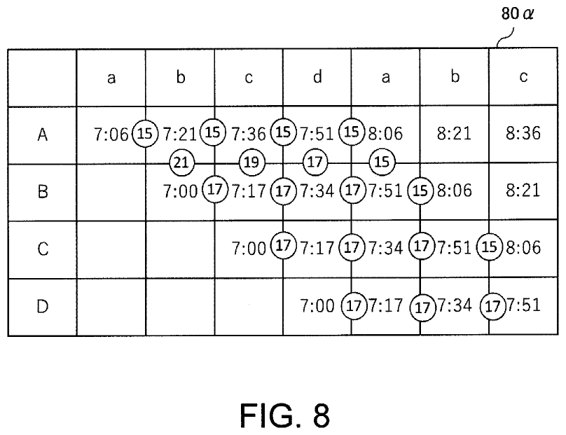

Specifically, when the delayed vehicle 52A is detected, the plan generation section 14 uses the delayed vehicle 52A as a reference to generate the running plan 80 of causing the delayed vehicle 52A to run at the first scheduled speed VS1 and temporarily making the speed of the other vehicles 52B to 52D lower than the first scheduled speed VS1 as the temporary running plan 80α. FIG. 8 is a diagram showing an example of the temporary running plan 80α. The first scheduled speed VS1 is not particularly limited so long as the vehicle 52 can safely run without impairing the convenience of the users. In the example of FIG. 8, the first scheduled speed VS1 is set to the scheduled speed VS set in the multiple vehicles 52 before the detection of the delayed vehicle 52A; i.e., the scheduled speed VS resulting in the inter-station required time TT of 15 minutes.

In the temporary running plan 80α, the departure timing of each of the vehicles 52 is reschedule based on the delayed vehicle 52A. In the example of FIG. 8, since the actual time of departure of the delayed vehicle 52A from the station 54a is 7:06, the timing of departure from the station 54a is 7:06 also in the temporary running plan 80α. For the delayed vehicle 52A, based on 7:06, a schedule is set for departure from each station at intervals of 15 minutes. Therefore, the temporary running plan 80α is prescribed such that the delayed vehicle 52A departs from the station 54b at 7:21 and from the station 54c at 7:36.

On the other hand, for the other vehicles 52B to 52D, the scheduled speed VS is temporarily reduced so that the departure interval to the following vehicle gradually approaches and finally becomes 15 minutes. Specifically, the other vehicles 52B to 52D are driven to run at the scheduled speed VS resulting in the inter-station required time of 17 minutes for only three stations. For example, for the vehicle 52B, the inter-station required time TT is 17 minutes from station 54b to station 54c, from station 54c to station 54d, and from station 54d to station 54a. By temporarily reducing the scheduled speed VS of the vehicle 52B, the departure interval to the following vehicle 52A gradually decreases. Finally, when the departure interval to the vehicle 52A becomes 15 minutes at the station 54a, the vehicle 52B is also driven to run at the first scheduled speed VS1. The same applies to the other vehicles 52C, 52D.

If it is desired to shorten the departure interval to the following vehicle to 15 minutes, it is conceivable that the departure time of the vehicle 52B at the station 54c is set to 7:21. However, in this case, it takes as long as 21 minutes from the departure of the vehicle 52B from the station 54b to the departure from the station 54c, and the travel time of the users on the vehicle 52B is significantly increased, so that the convenience of the users is impaired. Therefore, the plan generation section 14 stores a minimum of the scheduled speed VS that can ensure the convenience of the users as a minimum scheduled speed VSmin and prevents the scheduled speed VS of the vehicles 52 in the temporary running plan 80α from falling below the minimum scheduled speed VSmin. In the example of FIG. 8, the minimum scheduled speed VSmin is a speed resulting in the inter-station required time TT of 17 minutes.

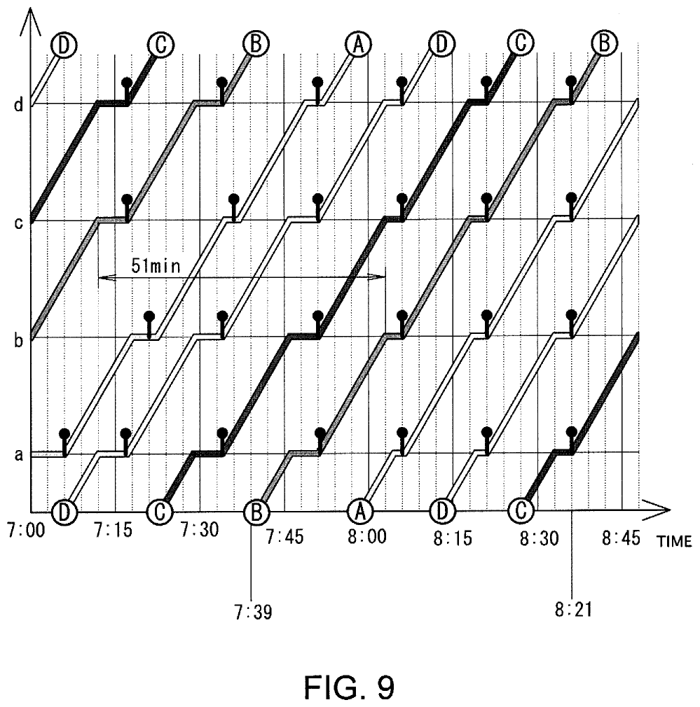

FIG. 9 is an operation timing chart of the vehicles 52 autonomously running in accordance with the temporary running plan 80α of FIG. 8. Hereinafter, autonomously running in accordance with the temporary running plan 80α will be referred to as “temporary running”. Pin-shaped marks of FIG. 9 indicate the departure timings of the vehicles 52 defined in the temporary running plan 80α.

In the temporary running plan 80α, the other vehicles 52B to 52D are regulated to temporarily run at a reduced speed lower than the first scheduled speed VS1. Since the scheduled speed VS can easily be adjusted by increasing the stop time TS at the station 54, the other vehicles 52B to 52D run in accordance with the schedule as in the temporary running plan 80α. For example, for the vehicle 52B, the scheduled speed VS is made lower than the first scheduled speed VS1 by increasing the stop time TS from the usual 3 minutes to 6 minutes.

On the other hand, in the temporary running plan 80α, the delayed vehicle 52A is regulated to run at the first scheduled speed VS1. However, in the initial stage of the temporary running, the delayed vehicle 52A has a wide operation interval from the preceding vehicle 52B, and therefore, the users tend to concentrate on the delayed vehicle 52A, so that the stop time TS tends to become longer. Therefore, in the initial stage of the temporary running, the delayed vehicle 52A is slightly delayed with respect to the temporary running plan 80α. For example, while the delayed vehicle 52A is regulated to depart from the station 54b at 7:21, the delayed vehicle 52A departs at 7:22 in the example of FIG. 9. However, such a delay gradually disappears as the temporary running is continued. As a result of continuing the temporary running, at 8:21, all the vehicles 52 return to the equal interval operation in which the operation intervals become uniform.

In this way, by continuing the running in accordance with the temporary running plan 80α, the non-uniform state of the running intervals can be eliminated. However, in the temporary running plan 80α, the speed of the other vehicles 52B to 52D is reduced for a long period, which may reduce the convenience of the users using these other vehicles 52B to 52D. For example, it is assumed that a user gets on the vehicle 52B arriving at 7:12 at the station 54c and travels to the station 54b. According to the temporary running plan 80α, the vehicle 52B arrives at the station 54b at 8:03, so that the travel time from the station 54c to the station 54b is 51 minutes. This is 6 minutes longer than the travel time of 45 minutes in the case of normal operation (in the case of FIG. 5).

To suppress such a prolongation of travel time, in this example, when the non-uniformity index UE decreases to the prescribed non-uniformity allowable value UEdef, the temporary running plan 80α is discarded to generate the return running plan 80β in which the other vehicles 52B to 52D are driven to run at the first scheduled speed VS1.

Specifically, the plan generation section 14 periodically confirms whether the non-uniformity index UE of the operation intervals is equal to or less than the prescribed non-uniformity allowable value UEdef after the temporary running is started. The non-uniformity allowable value UEdef is a value used as a reference for whether to stop the temporary running. The non-uniformity allowable value UEdef is not particularly limited so long as the value is larger than zero and is, for example, such a value of a non-uniformity index that the operation intervals can be made uniform again by the vehicles 52 autonomously adjusting the speed, etc. This non-uniformity allowable value UEdef is calculated in advance by the allowable value calculation section 19.

The allowable value calculation section 19 has a simulator virtually operating the transportation system. The allowable value calculation section 19 uses this simulator to determine the non-uniformity allowable value UEdef. For example, the allowable value calculation section 19 executes a simulation in multiple patterns with the non-uniformity index UE of the operation intervals changed at the start of the simulation and acquires a correlation between the non-uniformity index UE and the time required for eliminating the non-uniformity. The non-uniformity allowable value UEdef may be calculated as the non-uniformity index UE in which the time required for eliminating the non-uniformity is equal to or less than a certain time.

In this case, the simulator may be able to input a traffic congestion status of the running route 50 as a parameter. With such a configuration, an appropriate non-uniformity allowable value UEdef can be set depending on the traffic congestion status. Additionally, the simulator may be able to input at least one of the passenger information 84 and the waiting person information 86 as parameters. Specifically, the passenger information 84 includes the number and attributes of the passengers on the vehicles 52. This passenger information 84 greatly affects the boarding/alighting time of the vehicles 52, as well as a probability of occurrence of delay. The waiting person information 86 includes the number and attributes of waiting persons waiting for the vehicles 52 at the stations 54. This waiting person information 86 also greatly affects the boarding/alighting time of the vehicles 52, as well as a probability of occurrence of delay. By inputting the passenger information 84 or the waiting person information 86 as a parameter into the simulator, the non-uniformity allowable value UEdef can be more appropriately calculated.

In this example, the non-uniformity allowable value UEdef is calculated by the simulator; however, the non-uniformity allowable value UEdef may be calculated in another form. For example, the allowable value calculation section 19 may store a past operation history of the transportation system 10. The allowable value calculation section 19 may analyze this operation history, acquire a correlation between the non-uniformity index UE and the time required for eliminating the non-uniformity, and calculate the non-uniformity allowable value UEdef based on the correlation. The non-uniformity allowable value UEdef may be a variable value changing depending on a situation or may be a fixed value not changing depending on a situation. In this case, the allowable value calculation section 19 is not included, and the non-uniformity allowable value UEdef prescribed in advance is stored in the storage device 20.

The plan generation section 14 generates the return running plan 80β when the non-uniformity index UE of the operation intervals becomes equal to or less than the non-uniformity allowable value UEdef. The return running plan 80β prescribes a running schedule after the timing when the non-uniformity index UE becomes equal to or less than the non-uniformity allowable value UEdef. For example, in FIG. 9, it is assumed that the non-uniformity index of the operation intervals becomes equal to or less than the allowable value at around 7:39, which is 3 minutes after the departure of the delayed vehicle 52A from the station 54c. In this case, the return running plan 80β prescribes a running schedule after 7:39.

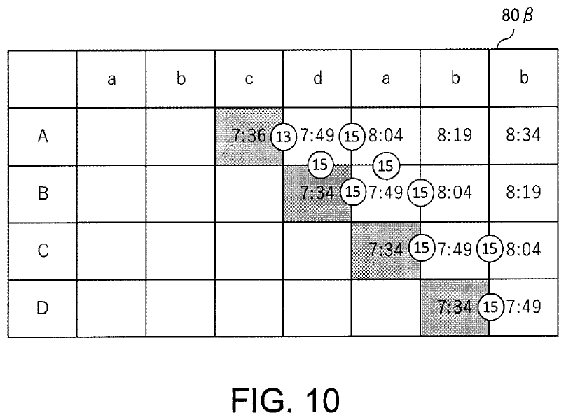

FIG. 10 is a diagram showing an example of the return running plan 80β. In the return running plan 80β, the other vehicles 52B to 52D are driven to run at the first scheduled speed VS1. For example, the departure timing of the vehicle 52B is prescribed such that the inter-station required time TT is set to 15 minutes. The departure timing of the vehicle 52B at the station 54a is 7:51 in the temporary running plan 80α and is 7:49 in the return running plan 80β, so that the required time is shortened by two minutes.

On the other hand, the delayed vehicle 52A is regulated to be temporarily increased in speed higher than the first scheduled speed VS1 so that the operation intervals become uniform. Specifically, the delayed vehicle 52A is regulated such that the inter-station required time TT from the station 54c to the station 54d is 13 minutes. While the operation interval from the preceding vehicle 52B is greatly extended, it is difficult to significantly shorten the inter-station required time TT; however, when the operation intervals come close to a uniform state to some degree, the inter-station required time TT can be shortened by adjusting the stop time TS. Therefore, while the non-uniformity amount UE of the operation intervals is equal to or less than the non-uniformity allowable value UEdef, the delayed vehicle 52A can be temporarily increased in speed higher than the first scheduled speed VS1.

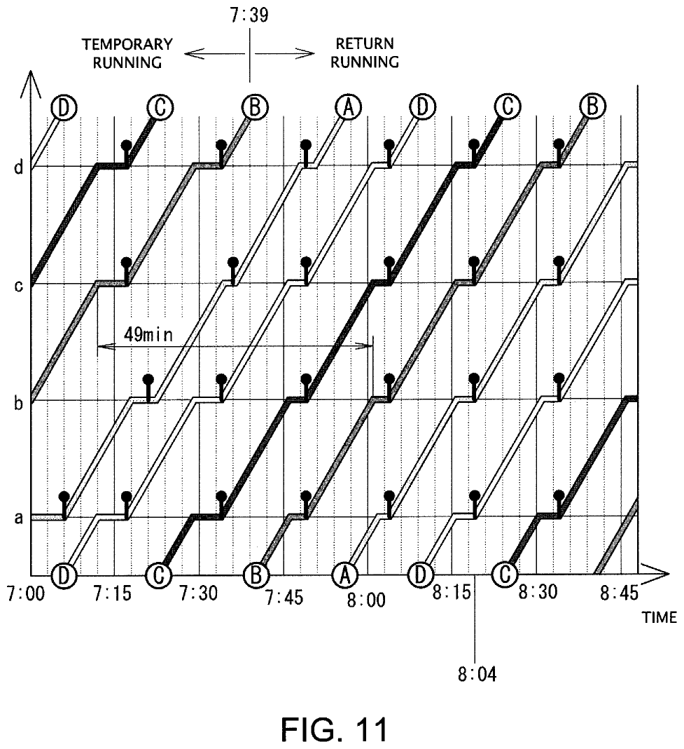

FIG. 11 is an operation timing chart of the vehicles 52 autonomously running in accordance with the temporary running plan 80α of FIG. 8 and the return running plan 80β of FIG. 10. Pin-shaped marks of FIG. 11 indicate the departure timings of the vehicles 52 defined in the running plan 80. In FIG. 11, the vehicles 52 autonomously run in accordance with the temporary running plan 80α until 7:39 and in accordance with the return running plan 80β from 7:39. Hereinafter, running in accordance with the return running plan 80β will be referred to as “return running”.

As shown in FIG. 11, immediately after the start of the return running, the delayed vehicle 52A is slightly delayed with respect to the return running plan 80β, and the operation intervals of the multiple vehicles 52 are not completely equal. However, since the departure interval between the vehicle 52B and the delayed vehicle 52A is reduced to some extent at the start of the return running, the concentration of users on the delayed vehicle 52A is mitigated. Consequently, the delayed vehicle 52A can shorten the stop time TS. By shortening the stop time TS, the delayed vehicle 52A can gradually eliminate the delay and come closer to the equal interval operation. In the example of FIG. 11, the delayed vehicle 52A eliminates the delay and returns to the equal interval operation at the timing of 8:04.

By switching to the return running from 7:39, the travel time of the other vehicles 52B to 52D can be shortened. For example, when a user gets on the vehicle 52B arriving at 7:12 at the station 54c and travels to the station 54b, the travel time is 51 minutes in the case of the temporary running plan 80α and is shortened to 49 minutes in the example of FIG. 11.

As described above, in this example, when the delayed vehicle 52 exists, the multiple vehicles 52 are temporarily driven to perform the temporary running and, when the non-uniformity index UE of the operation intervals becomes equal to or less than the non-uniformity allowable value UEdef as a result of the temporary running, the multiple vehicles 52 are driven to perform the return running. With such a configuration, the travel time of users can be prevented from becoming excessively long while suppressing a further increase in delay. As a result, the convenience of the transportation system 10 can be further improved.

### REFERENCE SIGNS LIST

transportation system, 12 operation management device, 14 plan generation section, 16 communication device, 18 operation monitoring section, 19 allowable value calculation section, 20 storage device, 22 processor, 24 input/output device, communication I/F, 50 running route, 52 delayed vehicle, 52 vehicle, 54 station, 56 automatic driving unit, 58 drive unit, 60 automatic driving controller, environment sensor, 64 in-vehicle sensor, 66 position sensor, 68 communication device, 70 station terminal, 72 in-station sensor, 74 communication device, 80 running plan, 80α temporary running plan, 80β return running plan, 82 running information, 84 passenger information, 86 waiting person information.

1. An operation management device comprising:
a plan generation section generating a running plan for each of multiple vehicles autonomously running along a prescribed running route;
a communication device transmitting the running plan to a corresponding vehicle and receiving running information indicative of an operation status from the vehicle; and
an operation monitoring section determining presence or absence of a delayed vehicle delayed with respect to the running plan and calculating a non-uniformity index of operation intervals of the multiple vehicles based on the running information, wherein
when the delayed vehicle exists and the non-uniformity index becomes equal to or greater than an allowable value, the plan generation section generates a temporary running plan for driving the delayed vehicle to run at a prescribed first scheduled speed and another vehicle to run at a speed reduced lower than the first scheduled speed, and wherein when the non-uniformity index of the operation intervals is reduced to a non-uniformity allowable value greater than zero as a result of the multiple vehicles running in accordance with the temporary running plan, the plan generation section generates a return running plan for driving the other vehicle to run at the first scheduled speed and the delayed vehicle to run at a speed temporarily increased higher than the first scheduled speed.

2. The operation management device according to claim 1, further comprising
an allowable value calculation section calculating the non-uniformity allowable value in advance by simulation.

3. The operation management device according to claim 2, wherein
the allowable value calculation section inputs, as a parameter of the simulation, at least one of passenger information transmitted from the vehicle as information about passengers of the vehicle and waiting person information transmitted from a station terminal disposed at a station on the running route as information about a waiting person waiting for the vehicle at the station.

4. An operation management method comprising:
generating a running plan for each of multiple vehicles autonomously running along a prescribed running route;
transmitting the running plan to a corresponding vehicle;
receiving running information indicative of an operation status from the vehicle; and
determining presence or absence of a delayed vehicle delayed with respect to the running plan and calculating a non-uniformity index of operation intervals of the multiple vehicles based on the running information, wherein
when the delayed vehicle exists and the non-uniformity index becomes equal to or greater than an allowable value, a temporary running plan is generated for driving the delayed vehicle to run at a prescribed first scheduled speed and another vehicle to run at a speed reduced lower than the first scheduled speed, and wherein
when the non-uniformity index of the operation intervals is reduced to a non-uniformity allowable value greater than zero as a result of the multiple vehicles running in accordance with the temporary running plan, a return running plan is generated for driving the other vehicle to run at the first scheduled speed and the delayed vehicle to run at a speed temporarily increased higher than the first scheduled speed.

5. A transportation system comprising:
multiple vehicles autonomously running in accordance with a running plan along a prescribed running route; and
an operation management device managing an operation of the multiple vehicles, wherein
the operation management device includes
a plan generation section generating the running plan for each of the multiple vehicles,
a communication device transmitting the running plan to a corresponding vehicle and receiving running information indicative of an operation status from the vehicle, and
an operation monitoring section determining presence or absence of a delayed vehicle delayed with respect to the running plan and calculating a non-uniformity index of operation intervals of the multiple vehicles based on the running information, wherein
when the delayed vehicle exists, the plan generation section generates a temporary running plan for driving the delayed vehicle to run at a prescribed first scheduled speed and another vehicle to run at a speed temporarily reduced lower than the first scheduled speed, and wherein when the non-uniformity index of the operation intervals is reduced to a non-uniformity allowable value greater than zero as a result of the multiple vehicles running in accordance with the temporary running plan, the plan generation section generates a return running plan for driving the other vehicle to run at the first scheduled speed and the delayed vehicle to run at a speed temporarily increased higher than the first scheduled speed.
